(19) United States
(12) Patent Application Publication
(10) Pub. No.: US 2026/0298784 A1
(43) Pub. Date: Oct. 1, 2026

(54) OPTIMIZING PARAMETERS AND LOCATIONS FOR NANOMECHANICAL TESTING USING MACHINE LEARNING

(71) Applicant: Bruker Nano, Inc., Santa Barbara, CA (US)

(72) Inventors: Benjamin Stadnick, Waconia, MN (US); Bernard Becker, Bloomington, MN (US); Douglas D. Stauffer, Minneapolis, MN (US); Ryan Major, Plymouth, MN (US)

(21) Appl. No.: 19/578,521

(22) Filed: Mar. 25, 2026

Related U.S. Application Data
(60) Provisional application No. 63/778,770, filed on Mar. 27, 2025.

(51) Int. Cl. G01N 3/02; G01N 3/30; G01N 3/56; G06N 7/01

(52) U.S. Cl. CPC G01N 3/02; G01N 3/30; G01N 3/56; G06N 7/01

(57) ABSTRACT

Various embodiments provide a method of conducting a nanomechanical process. The method can include establishing values for a set of variables. The method can include running a plurality of nanomechanical tests according to various sets of values for the set of variables. The method can include obtaining data in response to running the tests. The method can include using optimization techniques, such as Bayesian optimization to determine a new set of values for the set of variables. The method can include running an additional test according to the new set of values for the set of variables.

This application claims the benefit of U.S. Provisional Application No. 63/778,770, filed Mar. 27, 2025, the content of which is herein incorporated by reference in its entirety.

### FIELD

Various embodiments relate generally to the field of material testing and more specifically to improved methods and systems for conducting nanomechanical tests using Bayesian optimization to enhance testing efficiency and accuracy.

### BACKGROUND

Nanomechanical testing is a group of techniques that are used to measure the mechanical properties of materials at the nanoscale, such as hardness, scratch hardness, and elastic modulus. Traditional nanoindentation processes involve applying a known force to a material's surface using an indenter of known geometry and measuring the material's response (i.e., the resulting indentation). However, these processes often require extensive trial and error to optimize testing parameters, leading to increased time and resource consumption. Furthermore, the selection of test locations on a sample and the adjustment of testing variables can significantly impact the accuracy and relevance of the results. Similar issues also exist with other nanomechanical tests. Therefore, there is a need for an improved nanomechanical process that optimizes testing parameters and/or locations more efficiently and accurately.

### SUMMARY

Various embodiments provide a method of conducting a nanomechanical process. The method can include (a) establishing a first set of values for a set of variables, a second set of values for the set of variables, and a third set of values for the set of variables, (b) running a first nanomechanical test according to the first set of values for the set of variables, (c) obtaining a first set of data in response to running the first nanomechanical test, (d) running a second nanomechanical test according to the second set of values for the first set of variables, (e) obtaining a second set of data in response to running the second nanomechanical test, (f) running a third nanomechanical test according to the third set of values for the first set of variables, (g) obtaining a third set of data in response to running the third nanomechanical test, (h) using Bayesian optimization of the first set of data, the second set of data, and the third set of data to determine a fourth set of values for the first set of variables, and (i) running a fourth nanomechanical test according to the fourth set of values for the first set of variables to obtain a fourth set of data.

In an embodiment, wherein Bayesian optimization of step (h) includes: i. creating a surrogate model to approximate an objective function, ii. using the surrogate model to estimate the similarity between the first set of values, the second set of values, and the third set of values, iii. utilizing a decision policy to sample the surrogate model, and iv. utilizing the decision policy to use an acquisition function to determine the fourth set of values for the first set of variables.

In an embodiment, a Gaussian process is used to create and/or update the surrogate model.

In an embodiment, the method can further include: i. updating the surrogate model according to the fourth set of data, ii. utilizing the decision policy to use the acquisition function to determine a fifth set of values for the first set of variables. iii. running a fifth nanomechanical test according to the fifth set of values for the first set of variables to obtain a fifth set of data.

In an embodiment, the method can further include obtaining a fourth set of data in response to running the fourth test.

In an embodiment, the method can further include: incorporating the fourth set of data into the Bayesian optimization process of step (h), using Bayesian optimization to determine a fifth set of values for the first set of variables, and running a fifth nanomechanical test according to the fifth set of values for the first set of variables.

In an embodiment, the method can further include obtaining a fifth set of data in response to running the fifth test.

In an embodiment, the method can further include: incorporating the fifth set of data in the Bayesian optimization process, using Bayesian optimization to determine a sixth set of values for the first set of variables, and running a sixth nanomechanical test according to the sixth set of values for the first set of variables.

In an embodiment, the method can further include obtaining a sixth set of data in response to running the sixth test.

In an embodiment, the first set of variables includes a length of time for a hold segment and a length of time for an unload segment for the nanomechanical test.

In an embodiment, the first set of variables includes an approach speed and a length of time for a preloading segment for the nanomechanical test.

In an embodiment, the first set of variables includes at least two of the following: time for hold segment, time for unload segment, approach speed, time for a preloading segment, approach parameters to ensure adequate offset to test on a virgin surface, loading rate, loading type, drift analysis, maximum force, maximum displacement, displacement rate, test temperature, and dynamic parameters.

In an embodiment, wherein step (h) further includes determining a fifth set of values for the first set of variables and a sixth set of values for the first set of variable, and step (i) further includes running a fifth nanomechanical test according to the fifth set of value for the first set of variable to obtain a fifth set of data and running a sixth nanomechanical test according to the sixth set of values for the first set of variables to obtain a sixth set of data.

In an embodiment, the method can further include incorporating the fourth set of data, the fifth set of data, and the sixth set of data into the Bayesian optimization process of step (h), using Bayesian optimization to determine a seventh set of values for the first set of variables, and running a seventh nanomechanical test according to the seventh set of values for the first set of variables.

In an embodiment, the method can further include: using Bayesian optimization of a set of data that includes the data from previously run tests to determine a new set of values for the set of variables for an additional test, and running the additional test according to the new set of values to obtain additional data, wherein the step of using Bayesian optimization to determine a new set of values for the variables and running the additional test to obtain additional data are repeated until a predefined stopping criterion is met.

In an embodiment, the nanomechanical process is a nanoindentation process and each of the nanomechanical tests is a nanoindentation test.

In an embodiment, the nanomechanical process is a nanoscratch process and each of the nanomechanical test is a nanoscratch test. Various embodiments provide a nanomechanical system. The system can include a tool head can include a tool probe, the tool probe can include a probe tip, a sample stage configured for a sample to be placed upon, an actuator configured to move the probe tip into contact with a sample disposed on the sample stage, a control system can include non-transitory memory including instructions to perform the steps of: (a) establishing a first set of values for a set of variables, a second set of values for the set of variables, and a third set of values for the set of variables, (b) running a first nanomechanical test according to the first set of values for the set of variables, (c) obtaining a first set of data in response to running the first nanomechanical test, (d) running a second nanomechanical test according to the second set of values for the first set of variables, (e) obtaining a second set of data in response to running the second nanomechanical test, (f) running a third nanomechanical test according to the third set of values for the first set of variables, (g) obtaining a third set of data in response to running the third nanomechanical test, (h) using Bayesian optimization of the first set of data, the second set of data, and the third set of data to determine a fourth set of values for the first set of variables, and (i) running a fourth nanomechanical test according to the fourth set of values for the first set of variables to obtain a fourth set of data.

In an embodiment, wherein Bayesian optimization of step (h) includes: i. creating a surrogate model to approximate an objective function, ii. using the surrogate model to estimate the similarity between the first set of values, the second set of values, and the third set of values, iii. utilizing a decision policy to sample the surrogate model, and iv. utilizing the decision policy to use an acquisition function to determine the fourth set of values for the first set of variables.

In an embodiment, a Gaussian process is used to create and/or update the surrogate model.

In an embodiment, the instructions can further include: i. updating the surrogate model according to the fourth set of data, ii. utilizing the decision policy to use the acquisition function to determine a fifth set of values for the first set of variables. iii. running a fifth nanomechanical test according to the fifth set of values for the first set of variables to obtain a fifth set of data.

In an embodiment, the instructions can further include obtaining a fourth set of data in response to running the fourth test.

In an embodiment, the instructions can further include: incorporating the fourth set of data into the Bayesian optimization process of step (h), using Bayesian optimization to determine a fifth set of values for the first set of variables, and running a fifth nanomechanical test according to the fifth set of values for the first set of variables.

In an embodiment, the instructions can further include obtaining a fifth set of data in response to running the fifth test.

In an embodiment, the instructions can further include: incorporating the fifth set of data in the Bayesian optimization process, using Bayesian optimization to determine a sixth set of values for the first set of variables, and running a sixth nanomechanical test according to the sixth set of values for the first set of variables.

In an embodiment, the instructions can further include obtaining a sixth set of data in response to running the fifth test.

In an embodiment, the first set of variables includes a length of time for a hold segment and a length of time for an unload segment for the nanomechanical test.

In an embodiment, the first set of variables includes an approach speed and a length of time for a preloading segment for the nanomechanical test.

In an embodiment, the first set of variables includes at least two of the following: time for hold segment, time for unload segment, approach speed, time for a preloading segment, approach parameters to ensure adequate offset to test on a virgin surface, loading rate, loading type, drift analysis, maximum force, maximum displacement, displacement rate, test temperature, and dynamic parameters.

In an embodiment, wherein step (h) further includes determining a fifth set of values for the first set of variables and a sixth set of values for the first set of variable, and step (i) further includes running a fifth nanomechanical test according to the fifth set of value for the first set of variable to obtain a fifth set of data and running a sixth nanomechanical test according to the sixth set of values for the first set of variables to obtain a sixth set of data.

In an embodiment, the instructions can further include incorporating the fourth set of data, the fifth set of data, and the sixth set of data into the Bayesian optimization process of step (h), using Bayesian optimization to determine a seventh set of values for the first set of variables, and running a seventh nanomechanical test according to the seventh set of values for the first set of variables.

In an embodiment, the instructions further include the steps of: using Bayesian optimization of a set of data that includes the data from previously run tests to determine a new set of values for the set of variables for an additional test, and running the additional test according to the new set of values to obtain additional data, wherein the step of using Bayesian optimization to determine a new set of values for the variables and running the additional test to obtain additional data are repeated until a predefined stopping criterion is met.

In an embodiment, the nanomechanical system is a nanoindentation system and each of the nanomechanical tests is a nanoindentation test.

In an embodiment, the nanomechanical system is a nanoscratch system and each of the nanomechanical tests is a nanoscratch test.

Various embodiments provide a method of conducting a nanomechanical process. The method can include obtaining a sample, running a first nanomechanical test at a first location on the sample to obtain a first set of data, at a second location on the sample to obtain a second set of data, and a third location on the sample to obtain a third set of data, using Bayesian optimization of the first set of data, the second set of data, and the third set of data to determine a set of additional locations to test on the sample, and running a second nanomechanical test at the set of additional locations on the sample to obtain at least a fourth set of data.

In an embodiment, wherein using Bayesian optimization includes: developing a surrogate model, calculating a property value at each of the location for a of the sample with the surrogate module using kernel, calculating the gradient of the property value of the sample at each location in an x-y plane, and identifying regions on the sample with the largest gradient, determining and/or estimating a sample density of the first location, second location, and third location, and determining the set of additional locations to test based on the sample density and the regions identified as having the largest gradient.

In an embodiment, the set of additional locations to test includes at least 10 test locations.

In an embodiment, wherein each additional location includes an X-coordinate and a Y-coordinate.

In an embodiment, the method can further include: using Bayesian optimization of a set of data that includes the data from previously run tests to determine a new set of values for the set of variables for an additional test, and running the additional test according to the new set of values to obtain additional data, wherein the step of using Bayesian optimization to determine a new set of values for the variables and running the additional test to obtain additional data are repeated until a predefined stopping criterion is met.

Various embodiments provide a nanomechanical system. The system can include a tool head can include a tool probe, the tool probe can include a probe tip, a sample stage configured for a sample to be placed upon, an actuator configured to move the probe tip into contact with a sample disposed on the sample stage, a control system can include non-transitory memory storing instructions to perform the steps of: obtaining a sample, running a first nanomechanical test at a first location on the sample to obtain a first set of data, at a second location on the sample to obtain a second set of data, and a third location on the sample to obtain a third set of data, using Bayesian optimization of the first set of data, the second set of data, and the third set of data to determine a set of additional locations to test on the sample, and running a second nanomechanical test at the set of additional locations on the sample to obtain at least a fourth set of data.

In an embodiment, the set of additional locations to test includes at least 10 test locations.

In an embodiment, wherein each additional location includes an X-coordinate and a Y-coordinate.

In an embodiment, the instructions can further include the steps of: using Bayesian optimization of a set of data that includes the data from previously run tests to determine a new set of values for the set of variables for an additional test, and running the additional test according to the new set of values to obtain additional data, wherein the step of using Bayesian optimization to determine a new set of values for the variables and running the additional test to obtain additional data are repeated until a predefined stopping criterion is met.

In an embodiment, the nanomechanical system is a nanoindentation system and each of the nanomechanical tests is a nanoindentation test.

In an embodiment, the nanomechanical system is a nanoscratch system and each of the nanomechanical tests is a nanoscratch test.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a schematic view of a nanoindentation system in accordance with various embodiments herein.

FIG. 2 is a flowchart depicting a method in accordance with various embodiments herein.

FIG. 3 is a schematic of an optimization process in accordance with various embodiments herein.

FIG. 4 is a schematic of the optimization process in FIG. 3 with additional data in accordance with various embodiments herein.

FIG. 5 is a flowchart depicting a method in accordance with various embodiments herein.

FIG. 6 is a schematic of a loading and unloading process in a nanoindentation test in accordance with various embodiments herein.

FIG. 7 is a schematic of data from a nanoindentation test in accordance with various embodiments herein.

FIG. 8 is a schematic of data from nanoindentation tests in accordance with various embodiments herein.

FIG. 9 is a schematic of data from nanoindentation tests in accordance with various embodiments herein.

FIG. 10 is a schematic of modulus errors for different tests in accordance with various embodiments herein.

FIG. 11 is a flowchart depicting a method in accordance with various embodiments herein.

FIG. 12 is a schematic of a portion of a sample in a nanoindentation process in accordance with various embodiments herein.

FIG. 13 is a schematic of a portion of a sample in a nanoindentation process in accordance with various embodiments herein.

FIG. 14 is a schematic of a portion of a sample in a nanoindentation process in accordance with various embodiments herein.

FIG. 15 is a schematic of a portion of a sample with additional test locations for a nanoindentation process in accordance with various embodiments herein.

FIG. 16 is a schematic of a portion of a sample with additional test locations for a nanoindentation process in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

Various embodiments provided herein provide methods and systems that allow less experienced (i.e., non-expert) users the ability to quickly and accurately run nanomechanical tests, such as nanoindentation tests, or lateral (i.e., scratch) testing. The various methods and systems provided herein can include the use of an optimization system, such as Bayesian optimization, to quickly arrive at ideal or optimal parameters and/or locations to be used in a nanomechanical test. In various embodiments, the systems and methods provided herein can be used to optimize a single variable or multiple variables. This approach significantly improves the efficiency and accuracy of nanoindentation processes.

In the past users were required to guess or rely on previous knowledge when initiating a nanoindentation process or a scratch process. The proposed methods and systems significantly reduce the number of tests required to identify optimal testing parameters, thereby saving time and resources, and improving accuracy of the testing, especially for less experienced users.

In various embodiments, the method involves establishing initial sets of values for a set of variables related to the nanoindentation test, such as the length of time for hold and unload segments, approach speed, preloading segment time, and other relevant variables. One or more nanoindentation tests can be conducted based on the initial sets of values, and data can be obtained from these tests. The data from these tests can be used by the system to determine a next set of values for the variables in a following or subsequent test. In various embodiments, to determine test locations, the optimization process can include the use of a grid and interpolation to find high gradient locations for additional testing. In various embodiments, the optimization process for determining test parameters can include parameter optimization techniques, such as genetic algorithm or particle swarm optimization. In some embodiments, the optimization process, using the data from the conducted tests, can involve creating a surrogate model to approximate an objective function. The surrogate model can then be used to estimate the similarity between different sets of values and to determine new sets of values for subsequent tests. The surrogate model can be updated based on the results of each subsequent test to refine the optimization process continually and/or iteratively.

A nanomechanical process is a technique for characterizing the mechanical properties of materials. The method can usually involve the use of an indenter or probe tip with a precisely defined geometry, typically made of a hard material like diamond, to press into the surface of a sample or scratch the surface of a sample. The nanomechanical can be configured to apply a high-precision load and to accurately measure the displacement in the lateral and/or normal directions.

A nanomechanical process or procedure can include preparing the sample. In many embodiments, preparation of the sample includes ensuring the sample has a smooth and clean surface for accurate indentation measurements. A nanomechanical procedure can further include a selection of an indenter or probe tip. In various embodiments, the probe tip can include a sharp indenter, often with a pyramidal or spherical tip. The probe tip can be selected based on the specific requirements of the test or properties of the sample.

The controller can send a signal to the tool head to apply a controlled load to the indenter or probe tip pressing the indenter or probe tip into the sample's surface. The indentation depth can be measured simultaneously with the applied load, such as using high-resolution sensors. The indentation depth and load-displacement data obtained during the indentation process can be analyzed to determine the mechanical properties of the sample, such as hardness and elastic modulus. In some embodiments, the controller can send a signal to the tool head to press the indenter or probe tip into the sample's surface with a defined displacement. The corresponding load to reach the defined displacement can be measured.

The systems and methods provided herein ensure high precision and repeatability, making it suitable for various applications in materials science, nanotechnology, and related fields. The methods allow for detailed characterization of thin films, coatings, biological samples, and other advanced materials.

A lateral test, in some cases referred to as a scratch test or nanoscratch test, is a test used to evaluate the scratch resistance and/or adhesion properties of materials, such as thin films or coatings, at nanoscale. The method for a lateral test usually involves the use of an indenter or probe tip with a precisely defined geometry, typically made of a hard material like diamond, to press into the surface of a sample. The nanoscratch system is configured to apply a high-precision load and to accurately measure the displacement perpendicularly into the sample surface as we as laterally, parallel to the sample surface. In some cases, the lateral load can also be sensed orthogonally to the sliding direction.

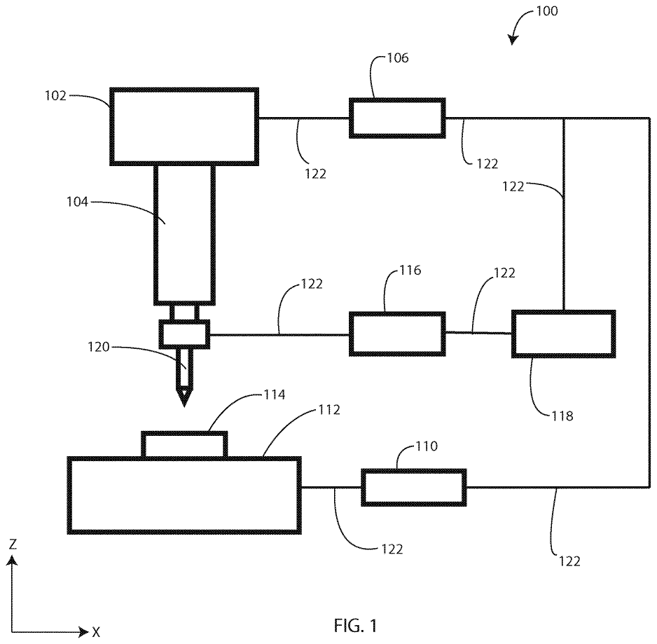

A nanomechanical test system can be configured to conduct nanoindentation tests and nanoscratch tests. FIG. 1 shows a schematic view of a nanomechanical test system 100 in accordance with various embodiments herein. The nanomechanical test system 100 can include a tool head 102 connected to a tool probe 104. The tool probe 104 can include a probe tip 120 (i.e., an indenter) at the distal end of the tool probe 104. The probe tip 120 can be configured to contact a sample 114. The sample 114 is the material that is being tested by the nanomechanical test system 100. The nanomechanical test system 100 can further include a table or stage 112 to accommodate the sample 114. The sample 114 can rest on or be secured to the stage 112 in preparation to be contacted by the probe tip 120. In various embodiments, the tool head 102 can be controlled to move relative to the sample 114 in the X-Y plane, such as to control a location of a subsequent sample. The tool head 102 can further be controlled to move relative to the sample in the Z-direction, such as to move the probe tip 120 into and out of contact with the sample 114.

The nanomechanical test system 100 can include a controller 110. The controller 110 can be in electrical communication with the other portions of the nanomechanical test system 100 via electrical conduits 122. The electrical conduits 122 can relay signals, such as control signals or testing result signals, between the components within the nanomechanical test system 100.

The nanomechanical test system 100 can include processor 118 and an amplifier 116 to process the signal from the tool probe 104 related to a testing event. The processor 118 and amplifier 116 can be in electrical communication with the controller 110, the sensing unit 106, and the tool probe 104 via the electrical conduits 122. In various embodiments, the sensing unit 106 can analyze the indentation or scratch in the sample or data related to the test to determine properties of the sample 114.

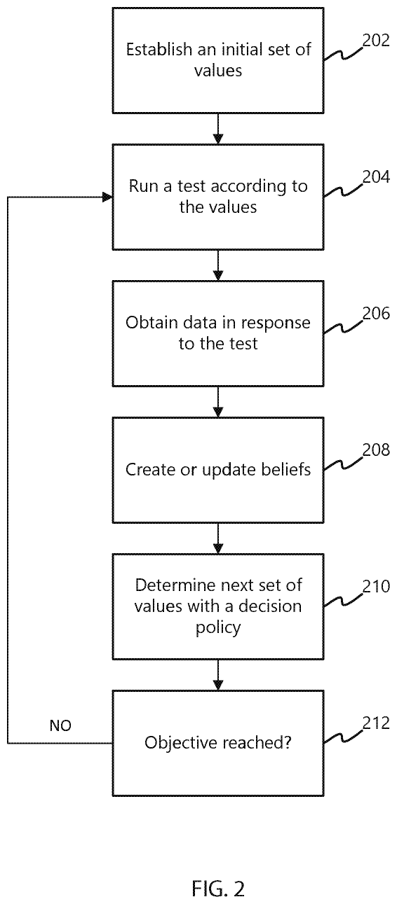

In various embodiments, the nanomechanical test system 100 can include one or more computer systems. In some embodiments, the one or more computer systems can include all or portions of the sensing unit 106, the controller 110, the amplifier 116, and the processor 118. In various embodiments, the computer system can include memory, such as non-transitory memory. In some embodiments, the memory can include instructions for implementing the methods described herein, such as those shown in FIGS. 2, 5, and 11. In various embodiments, the nanomechanical test system 100 can further include a user interface. The user interface can include a display and an input element. The display can show data or variable values to a user. The input element can be used by a user to input data or commands into the system.

The controller 110 can control various parameters or variables during a testing process. Variables that can be controlled and changed between various testing events can include the following:

Time for hold segment: In various embodiments, a time for hold segment (i.e., dwell time) can refer to a period during which the maximum load is maintained constant on the indenter after the load has been fully applied. In some embodiments, a time for hold segment can refer to period during which the displacement or the load is maintained without change at some point during the test, depending on the control mode. This hold segment can allow for observation of time-dependent deformation behaviors such as creep or stress relaxation in the sample being tested.

Time for unload segment: In various embodiments, a time for unload segment can refer to the period during which the applied load is gradually reduced or removed from the indenter after the peak load has been achieved. This segment can allow for capturing the elastic recovery of the sample and determining mechanical properties of the sample, such as hardness and elastic modulus.

Approach speed: In various embodiments, approach speed can refer to the rate at which the indenter moves towards the surface of the sample being tested before contact is made. This variable can influence the accuracy and the reliability of the indentation measurement. A consistent and controlled approach speed can help ensure that the initial contact between the indenter and the sample is gradual and minimizes potential errors due to dynamic effects.

Time for a preloading segment: In various embodiments, the time for a preloading segment can refer to the duration during which a small, initial load is applied to the indenter before the main loading phase begins. This preloading step can ensure that the indenter makes proper contact with the surface of the sample and any surface roughness or irregularities are accounted for. It can help in establishing a stable baseline before the primary indentation load is applied, which contributes to more accurate and reliable measurement of the mechanical properties of the sample.

Loading rate: In various embodiments, loading rate can refer to the speed at which the load is applied to the indenter during an nanoindentation test. It can be expressed in units of load per time, such as millinewtons per second, mN/s, or m/sec, such as if running in displacement control mode. The loading rate can also be expressed in units of inverse time when the loading rate changes as a function of the current load, such as nm/s/nm or mN/S. mN. The loading rate can affect the indentation results, including the measured hardness and elastic modulus. A controlled loading rate helps ensure accurate and repeatable measurements by managing dynamic effects and potential artifacts during the indentation process.

Loading type: In various embodiments, the loading type can refer to the specific way in which the load is applied to the indenter. In some embodiments, the loading type can be linear. In some embodiments, the loading type can be exponential. Various loading types can include constant loading rate, step loading, dynamic loading, and ramp loading. Constant loading can refer to a load that is increased at a constant rate until the maximum load is reached. Step loading can refer to a load that is applied in discrete steps with holding periods at each level of load. Dynamic loading can refer to a load that applied in a cyclic manner, where the load is continuously varied. Ramp loading can refer to a load that is gradually increased in a controlled manner. The choice of loading type can influence the response of the sample and the resulting measurements.

Drift analysis: In various embodiments, drift analysis can refer to the process of identifying and correcting for any unwanted, gradual changes in the position of the indenter or the sample during a nanoindentation test. These changes, often caused by factors like thermal expansion or contraction, can affect the accuracy of the measurements. By analyzing drift, corrections can be applied to the data to ensure more precise results. In some cases, the difference between drift and other errors in nanoindentation, such as a false contact, or creep into a soft sample, can be determined.

Maximum force: In various embodiments, maximum force can refer to the highest load applied by the indenter to the sample being tested. The maximum force or maximum load can define the peak stress exerted on the sample, allowing for the measurement of properties such as hardness, elastic modulus, and other mechanical characteristics of the sample. Understanding the maximum force can help ensure accurate characterization of the sample's behavior under load.

Maximum displacement: In various embodiments, maximum displacement can refer to the greatest depth or distance that the indenter penetrates into the sample during the nanoindentation test. The maximum displacement can be taken or established at the point of maximum load application. The maximum displacement can help in understanding various things, such as the volume of the material being tested and the associated lateral spacing of subsequent indents.

Displacement rate: In various embodiments, the displacement rate, for a test run under displacement control feedback, can refer to the speed at which the indenter moves into or out of the sample being tested. This rate can be expressed in units of displacement per time, such as nanometers per second, nm/s. A controlled displacement rate ensures precise and reliable data collection, managing dynamic effects and potential errors in the results. In various embodiments, the dynamic effects can be measured.

Test temperature: In various embodiments, the test temperature can refer to the temperature at which the sample and/or environment surrounding the sample is at during the test. In various embodiments, the temperature can be controlled. The test temperature can be controlled, because temperature can influence the mechanical properties of some samples depending on the material(s). For instance, materials can exhibit different behaviors such as increased ductility or decreased hardness at elevated temperatures. By controlling and specifying the test temperature, more accurate and consistent measurements that reflect the sample's behavior under specific thermal conditions can be obtained.

Dynamic parameters: In various embodiments, dynamic parameters can refer to the variables and conditions that can change during the test to gather additional data about the mechanical properties of the sample. In some embodiments, the dynamic parameters can include load amplitude, displacement amplitude, and/or frequency. These parameters can involve varying loads, displacement rates, and frequencies to observe the sample's behavior under different conditions, such as different time-based conditions.

Approach parameters: In various embodiments, the approach parameters can ensure adequate offset to test on a virgin surface. This can refer to the settings and conditions used to ensure that the indenter starts the test at a sufficient distance from any surface irregularities or contamination, such as caused by previous tests. This typically involves setting an initial offset or starting position for the indenter that is higher than the surface roughness or any pre-existing features on the material. By doing so, the indenter can move smoothly into the material without being affected by surface artifacts, ensuring that the test measures the intrinsic properties of the material rather than surface anomalies.

### Lateral Testing (scratch Testing) Parameters: in Addition to Indentation Tests,

moving the probe laterally across the sample surface while simultaneously applying and measuring all, or a combination thereof, the normal and/or lateral displacement, and/or normal and/or lateral force is possible. This allows for measuring the frictional forces, the coefficient of friction, the scratch hardness, and sheer, peel, and critical failure of the material. In addition, these measurements can provide a basis for calculating the Poisson ratio and measures of delamination. Control of force and/or displacement application rates in the lateral direction in addition to the normal direction parameters mentioned above is also possible. It should be understood that in addition to indentation test, the systems and methods provided herein can also be used for lateral testing (i.e., scratch testing).

The optimization systems and methods provided herein can optimize a single variable, such as by keeping one or more other variables constant, or optimize multiple variables, such as two variables, as described below. Bayesian optimization is a method for optimizing complex objective functions, particularly useful in machine learning for tuning parameters. A method for Bayesian optimization is described in Bayesian Optimization by Roman Garnett, 2023, Cambridge University Press with a Digital Object Identifier of https://doi.org/10.1017/9781108348973, which is hereby incorporated by reference in its entirety. A method for Bayesian optimization is also described in “Recent Advances in Bayesian Optimization”, by Xilu Wang, Yaochu Jin, Sebastian Schmitt, Markus Olhofer, published in arXiv on Nov. 11, 2022 with a Digital Object Identifier of https://doi.org/10.48550/arXiv.2206.03301, which is hereby incorporated by reference in its entirety. The methods can employ a probabilistic or surrogate model, typically a Gaussian process, to predict the performance of various configurations of values. The surrogate model can be iteratively updated based on additional observed outcomes to provide more accurate predictions.

Generally, a Bayesian optimization process can include defining the problem or an objective function. The objective function, intended to be optimized, including the relevant parameters/variables and their respective ranges can be defined. Next, a surrogate model can be initiated. In many cases a Gaussian process can be used to create or update the surrogate model. The surrogate model can approximate the objective function based on known data (i.e., data from initial or previously conducted tests).

After creating or updating the surrogate model, an acquisition function can be selected. The acquisition function can be selected to balance exploration and exploitation by determining the next set of parameters to evaluate or test. The acquisition function can prioritize exploration, such as to obtain further data in previously untested ranges for the parameters/variables in order to reduce the “unknown” ranges. The acquisition function can prioritize exploitation to obtain additional relevant data, such as by focusing on ranges of data that are known to produce good results. Since both exploration and exploitation can be advantageous, the acquisition function can balance the desire for exploration and exploitation.

Once the next set of values for the parameters has been determined. An additional test can be conducted and new data as a result of the test can be obtained. In some embodiments, multiple tests can be conducted according to multiple different values for the parameters, such as to obtain multiple new sets of data prior to updating the surrogate model. After additional data has been obtained from a test (or from multiple tests) the surrogate model can be updated to account for the new data. After the surrogate model has been updated with the new data, the process of obtaining new parameters and performing a new test can be repeated. The steps of updating the surrogate model with new data, determining new values for the parameters, and conducting a test according to the new values to obtain new data can be repeated. The process can be iterative. Each update to the surrogate model can increase the accuracy and the confidence in of the surrogate model. The iterative process can be repeated until a satisfactory solution is found or a predefined stopping criterion is met.

For the selection of test locations, the objective can be said to have been met when the sample surface has been sufficiently explored. This can be quantified by reaching a minimum threshold of parameter gradient over test location density. In various embodiments, the stopping criterion can be defined as when the sample surface has been sufficiently explored, such as by reaching a threshold value for a sample density across the sample surface.

For the optimization of test parameters, the objective can be said to have been met when the parameters converge, such as the parameters change minimally over successive iterations. Such minimal changes can be indicative that the optimal test parameters have been found. In some embodiments, the process can be stopped early if the objective function value, such as uncertainty, falls below a certain threshold indicating the test parameters are good enough.

In various embodiments, a defined number of iterations (e.g., a maximum number of iterations) or a time limit can define the stopping criterion.

The Bayesian optimization method ensures efficient exploration and exploitation of parameter ranges, reducing the computational cost associated with tuning machine learning models. This approach is particularly advantageous in scenarios where evaluations are expensive or time-consuming, such as in deep learning, reinforcement learning, and complex simulation-based tasks.

FIG. 2 shows a flow chart depicting method steps according to various embodiments. Various embodiments provided herein can include an optimization process, such as a Bayesian optimization process. FIG. 2 shows steps included for a Bayesian optimization process according to various embodiments.

The method of FIG. 2 can include determining an initial set of values. The initial set of values can be based on previous experience, previous tests, or prior beliefs 202. In other embodiments, the initial set of values can be provided as standard starting values. In some embodiments, the initial set of values can be input into the system by a suer such as through a user interface.

Once the initial set of values is obtained or established, an experiment or test can be conducted 204 using the initial set of values. The test can produce data or results as an output 206. In various embodiments, the output can be saved or stored in the system, such as in a memory component of the system. The data from the test can be used to update the “prior beliefs” of the test 208. In many embodiments, a surrogate model is created or updated using the test output from step 206 in step 208. Various embodiments can further include determining a next set of values to use 210. In some embodiments, a decision policy can be used to establish the next set of values to use. The decision policy can balance exploration of ranges of values that have not yet been tested with exploitation of ranges of values that are known (or believed) to produce positive results. The method can include determining if the objective of the testing has been completed 212. If the objective of the testing has been completed, the process can be stopped. However, if the objective of the testing has not yet been reached, the next set of values determined in step 210 can be used in a subsequent experiment returning to step 204. As long as the objective has not yet been reached or completed, the method can include repeating steps 204, 206, 208, and 210. With each iteration of these steps 204, 206, 208 and 210, the “beliefs” or surrogate model can be updated to a more accurate state. The more accurate state can better reflect the true objective function being modeled.

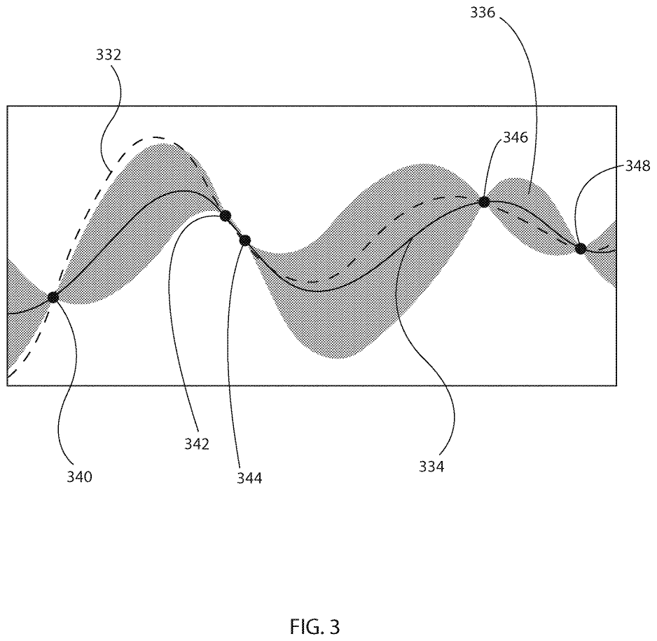

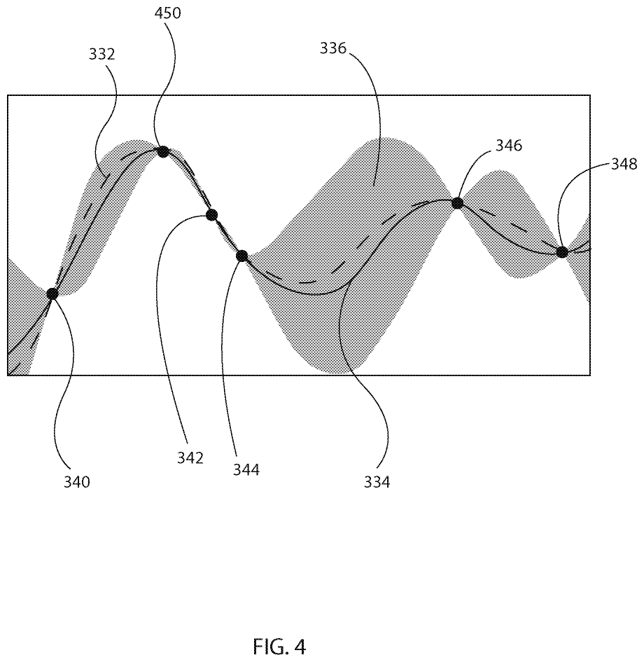

FIGS. 3 and 4 show a schematic of a model being updated through an iteration of the steps shown in FIG. 2 in accordance with various embodiments. Specifically, FIG. 3 shows an objective or true function 332. This true objective function 332 is not known, but shown in the schematics for explanation purposes. The surrogate model 334 or “beliefs” is shown in FIG. 3. The surrogate model 334 or “beliefs” are based on the five known points 340, 342, 344, 346, 348. The confidence interval 336 is also shown in FIG. 3. It is clear from FIG. 3 that the objective function 332 and the surrogate model 334 are equal at the known points 340, 342, 344, 346, 348. The confidence interval is also the tightest (least unknown) at points 340, 342, 344, 346, 348, since these values are known to be true from testing.

FIG. 4 shows the same schematic from FIG. 3 with a newly observed value or known point 450. Between the time the schematic in FIG. 3 was created and the time the schematic of FIG. 4 was created, another test was conducted to obtain additional data, known point 450. When comparing FIG. 3 with FIG. 4, it can be seen that the surrogate model 334 has updated to incorporate the newly learned data (i.e., known point 450). With the additional known data, the surrogate model 334 more closely represents the true function 332. Further, with the additional known data, the confidence interval is substantially tighter around the new data, point 450. Subsequent steps can be used to determine which values should be used for additional testing.

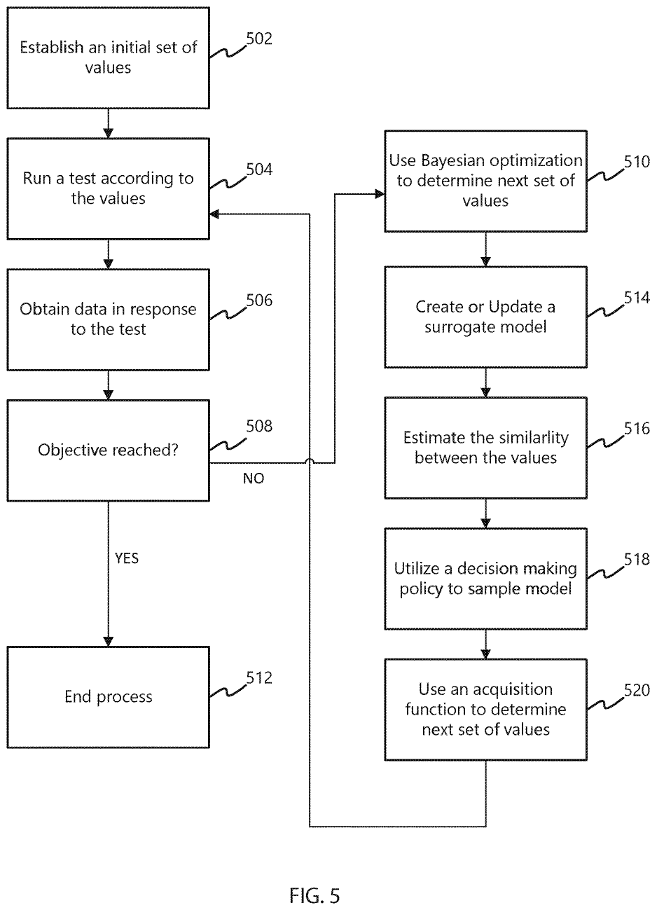

In various embodiments provided herein, Bayesian optimization can be utilized to determine values for various variables in subsequent nanoindentation tests as mentioned above. FIG. 5 shows a flowchart depicting a method of incorporating Bayesian optimization into nanoindentation in accordance with various embodiments herein.

Similar to as discussed with reference to FIG. 2, an initial step can include establishing values for a set of variables for a first nanoindentation test 502. In some embodiments, this can include a batch of variables, such as a first set of values for the first set of variables, a second set of values for the first set of variables, and a third set of values for the first set of variables, such as in order to conduct three nanoindentation tests. In other embodiments, this can include a single set of values for the set of variables.

Once the values for the variables have been established, one or more experiments or tests can be conducted 504. The one or more tests can be run in accordance with the values established in step 502. In response to conducting the test(s), data can be obtained as an output from the test 506.

Based on the output of the test(s), it can be decided whether or not the objective of the testing has been met 508. If the objective has been met, the process can be terminated or stopped 512. If the objective has not yet been met, Bayesian optimization can be used to determine the next values for the set of variables for a subsequent test 510.

Using Bayesian optimization to determine the next set of values for the variables can include updating or creating a surrogate model to approximate an objective function 514. In some embodiments, a Gaussian process can be used to create and/or update the surrogate model. In some embodiments, a kernel function can be a component of the surrogate model. The surrogate model can be determined via a Gaussian process. The kernel function can define the relationship between different points in the input space. The kernel function can measure the similarity or correlation between these input points.

In various embodiments, the surrogate model can be used to approximate the objective function that is intended to be optimized. In Bayesian optimization, Gaussian processes can be used as the surrogate model, because they can provide a probabilistic framework for modeling the unknown objective function. In various embodiments, the kernel function within the Gaussian process can define how the values of the function at different points are correlated. It can include assumptions about the function's smoothness and variability. In various embodiments, the kernel function can include the Radial Basis Function (RBF) or squared exponential kernel. In various embodiments, the kernel function can shape the surrogate model by determining the covariance structure of the function values. This can allow the Gaussian process to make predictions about the objective function and quantify uncertainty, guiding the selection of the next query point(s) (e.g., values of the variables) in the optimization process. In other embodiments, a neural network can be used to create or update the surrogate model. As mentioned above, the method can include determining or estimating the similarity between values using the surrogate model 516.

In various embodiments, the kernel function can play a critical role within Gaussian processes, which form the surrogate models in the optimization framework. A kernel function is utilized to define the correlation between data points in the input space, providing a measure of similarity that underpins predictions made by the Gaussian process. The selection and implementation of the kernel function thus can directly affect the capability of the Gaussian process to model the unknown objective function with accuracy. In many embodiments, the Radial Basis Function (RBF) kernel, also known as the squared exponential kernel, can be employed due to its ability to capture smooth and continuous functions. Kernel functions such as Matérn or polynomial kernels may be used depending on the nature of the data and the function's characteristics. Additionally, a deep kernel can be employed in some embodiments, such as when dealing with complex, high-dimensional data, as it allows the model to learn rich representations of the data, leading to accurate and robust predictions of diverse datasets.

Functioning of the kernel can include managing the covariance structure among observations, essentially controlling the smoothness with which changes in parameters impact the output space. By quantitatively evaluating the degree to which two points in the parameter space are similar, the kernel influences the Gaussian process's capacity to interpolate and extrapolate the data efficiently. In various embodiments, the choice of a kernel can be aligned with the specific dynamics of the material under investigation and the degree of stochastic variability anticipated. Kernel functions can also be pivotal in the formation of the acquisition function since they impact the uncertainty estimate, which guides the selection of test parameters in subsequent iterations.

Alternatives to utilizing kernel-based Gaussian processes include leveraging other forms of machine learning models such as neural networks, which are adept at capturing non-linear relationships in data. However, the probabilistic nature of Gaussian processes, which are enhanced by kernel functions, can offer advantages in quantifying prediction uncertainties, in various embodiments. These uncertainties enable effective determination of subsequent test parameters with an appropriate balance of exploration of unexplored parameter spaces and exploitation of promising configurations identified through earlier tests.

The method can further include utilizing a decision policy to sample the model 518. The decision policy can determine what values will be tested next. The method can also include utilizing the decision policy to use an acquisition function to determine the next set of values for the set of variables 520, such as for a subsequent test. Once the next set of values is determined, the method can return to step 504 using the newly established values.

The decision policy can determine if the objective has been met or if additional tests are necessary. If additional tests are needed, the decision policy can call on the acquisition function to obtain the values for the next test. In various embodiments, the decision policy can call on the acquisition function multiple times to create a batch of values for a batch of tests, and then determine in which order to perform said tests (and their corresponding values). The order can be optimized to provide the shortest amount of time to conduct the batch of tests.

For the test location determination, the acquisition function can seek out the location or locations of greatest interest. One embodiment of this is to target areas of interest, such as areas where the sample properties are changing or changing most rapidly. This can be done by finding the steepest gradient in the surrogate model. The result of this targeting is a high density of tests near interesting features in the sample and low density of tests in less interesting areas such as where the sample properties are constant (i.e., less interesting). In various embodiments, the acquisition function can avoid placing indents too close together to avoid cross test interference of the measured properties. This can be done by cross-referencing potential test locations with tests that have already been performed. The acquisition function may also avoid areas of sample imperfections. This can be done by looking at abnormalities in the Z position or test results of tests near the potential location.

For test variables optimization, the acquisition function can determine the next set of parameters to test. It can balance exploration and optimization. Exploration can be performed by testing where the data density of test in the parameter space is low. Optimization can be performed by testing in areas or ranges where the objective value is best.

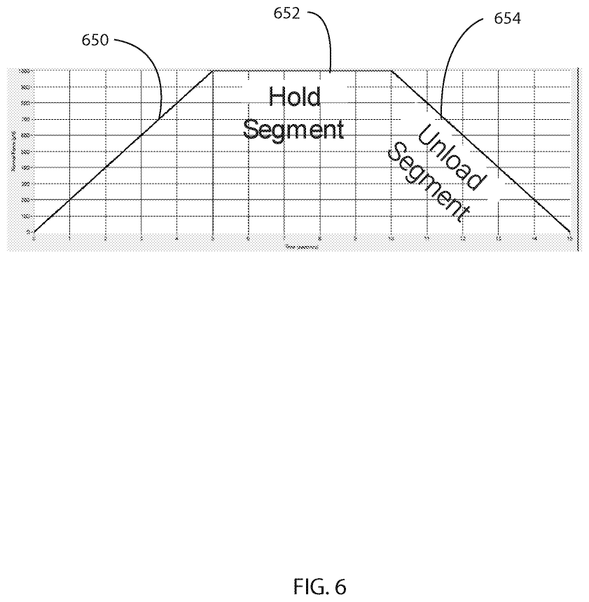

FIGS. 6-10 show an example of a Bayesian optimization process being used to determine values for a hold time and an unload time. As described above, hold time or a hold segment can refer to a portion of the test where the load (e.g., maximum load) is held constant. The unload segment or unload time can refer to a portion of the test where the load is withdrawn or reduced.

FIG. 6 shows an example of a loading process that includes a loading segment 650, a hold segment 652 and an unload segment 654. FIG. 6 shows a schematic of a nanoindentation test with the force or load on the vertical axis, and time on the horizontal axis. The process can include a loading segment 650. Starting from the origin, the force increases with time as the indenter penetrates the sample. The process can include a hold segment 652. Upon reaching the maximum force or load, the graph levels off, indicating a period where the load is maintained constant over time. This is depicted as a horizontal line on the graph, representing the hold segment 652. After the hold segment, the process can include an unloading segment 654. After the hold period, the force can be gradually reduced.

The amount of time of each segment can vary between tests. Further, the ratio of the amount of time between each segment can also vary between tests. Understanding the variables and their relationships with each other can help in analyzing time-dependent behaviors, such as creep during the hold segment, and the sample's elastic recovery during the unloading segment.

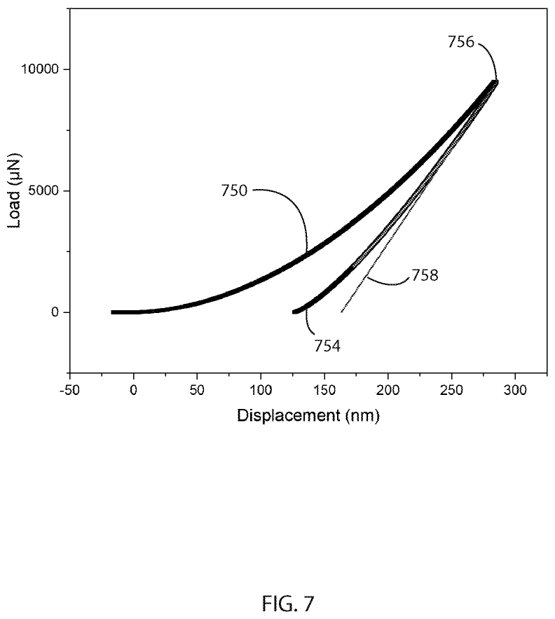

FIG. 7 shows a curve from a nanoindentation test in accordance with various embodiments. Specifically, FIG. 7 shows the relationship between a load and the displacement. The load-displacement curve in a nanoindentation test is a graphical representation of the relationship between the applied load (i.e., force) on the vertical axis and the penetration depth (i.e., displacement) on the horizontal axis of the indenter into the sample.

The curve starts with a small initial load as the indenter makes contact with the surface of the sample. As the load increases, the loading phase 750, the indenter penetrates deeper into the sample, resulting in a rising curve. The curve reaches a peak when the maximum load 756 is applied. In some embodiments, the load can be held constant for a period to observe time-dependent deformation behaviors (i.e., dwell time). In various embodiments, the load can be gradually reduced, unloading phase 754, and the indenter retracts from the sample. This segment can show how the sample recovers elastically. The curve ends when the load is completely removed, and the final depth of indentation can be recorded.

The shape of the unloading curve can be particularly important as it provides information about the elastic modulus and hardness of the sample. The slope of the unloading curve is related to the stiffness of the contact, while the area under the curve can be used to calculate hardness. Using this data a surrogate model can be built, such as with a Gaussian process. This data can be captured by the sensing unit 106. In some embodiments, this data can be display on the user interface.

In the context of a load vs. displacement curve for a nanoindentation test, dF/dh represents the slope of the curve at any given point. Line 758 in FIG. 7 represents the slope at a point. The variable F denotes the applied force (load), and the variable h denotes the indentation depth (displacement). This derivative, dF/dh, can be used for understanding the mechanical properties of the material. During a loading portion of the test, the derivative provides insight into the materials stiffness and how it responds to an increasing load. During an unloading portion of the test, it can be used to calculate the modulus of the material.

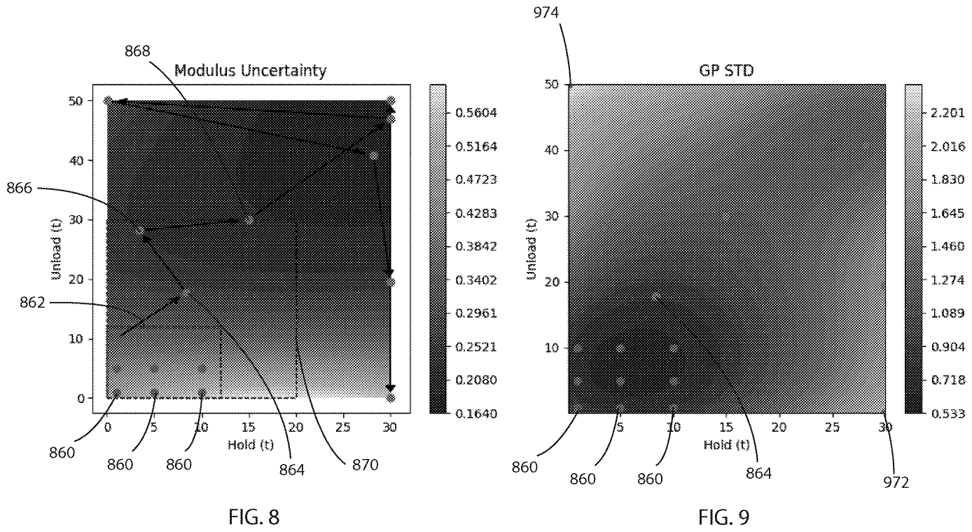

FIG. 8 shows the modulus uncertainty of various values for the variables of unload time and hold time. The tested values are shown as points 860 located in the first range of values 862. The Bayesian optimization process can provide a user with subsequent values to test, such as values 864, 866 and 868 that are located in a second range of values 864. In various embodiments, the second range of values can partially overlap with the first range of values. In various embodiments, the second range of values 870 can include values that were not included in the first range of values 862. Additional values can be suggested in a third range of values.

FIG. 9 shows the Gaussian process standard deviation with the tested points and suggested next points shown in FIG. 8. FIG. 9 shows the standard deviation from the Gaussian process. It can be seen in FIG. 9 that some of the suggested next values can be located where the standard deviation is the largest, such as point 972 and point 974.

Within the context of optimizing parameters and locations for nanoindentation using machine learning, the Gaussian process plays a pivotal role as the surrogate model in the Bayesian optimization framework. The Gaussian process is a powerful statistical tool that enables the modeling of the objective function, which in the case of nanoindentation, could be related to optimizing the mechanical properties measurements such as hardness and elastic modulus of materials at the nanoscale. The essence of employing a Gaussian process lies in its ability to provide a probabilistic prediction of the objective function's outcomes based on prior data and to estimate the uncertainty of these predictions. This characteristic is particularly beneficial in the nanoindentation context, where the exact relationship between the testing parameters and the mechanical properties of materials may not be explicitly known or may be highly nonlinear.

The Gaussian process utilizes a kernel function to define the covariance between any two points in the parameter space, which in turn, reflects how changes in the nanoindentation test parameters might influence the test outcomes. This kernel function can be crucial as it encapsulates assumptions about the function's smoothness and how quickly the outputs can change as the inputs vary. By adjusting the kernel's parameters, the Gaussian process can be finely tuned to the specific characteristics of the nanoindentation data, allowing for more accurate predictions and better guidance for selecting the next set of parameters to test.

In practice, after conducting an initial set of nanoindentation tests and gathering data, the Gaussian process model is updated, enhancing its predictions for the next set of parameters that are likely to yield valuable information. This iterative process continues, with each cycle of Bayesian optimization using the Gaussian process to refine the search for optimal testing parameters and locations. The model's ability to quantify uncertainty in its predictions is particularly useful for balancing exploration of untested parameter spaces against exploitation of known good parameter regions. This balance is critical for efficiently navigating the complex parameter space of nanoindentation tests, ensuring that each new test contributes maximally to the understanding of the material's properties while minimizing the number of tests needed.

Furthermore, the Gaussian process model supports the decision-making process by utilizing an acquisition function. This function analyzes the model's predictions and uncertainties to recommend the most informative next test, thereby systematically reducing uncertainty and converging on the optimal nanoindentation parameters and locations. This approach significantly streamlines the nanoindentation testing process, making it faster, less resource-intensive, and capable of achieving higher accuracy and reliability in measuring material properties.

The integration of Gaussian processes into the Bayesian optimization framework for nanoindentation testing represents a significant advancement in the field of material testing. It offers a sophisticated, data-driven approach to identifying optimal testing parameters and locations, thereby enhancing the efficiency and effectiveness of nanoindentation tests. This methodology not only saves time and resources but also enables a deeper understanding of material properties at the nanoscale, contributing to advancements in materials science and engineering.

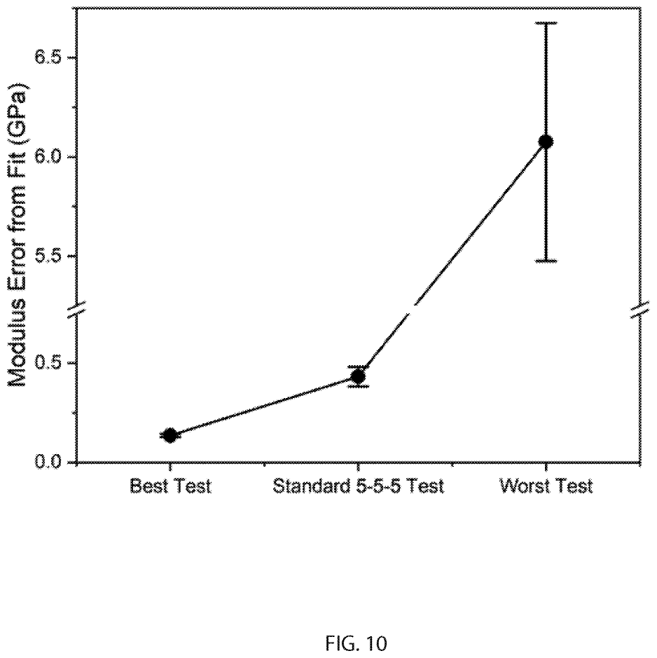

FIG. 10 shows a Modulus error fit from various test from various test. As shown, the Bayesian optimization can provide the best test values. In contrast there is less certainty with a standard 5-5-5 Test. The worst test clearly shows a large amount of error, least certainty, compared to the standard 5-5-5 test, which has more error than the best test.

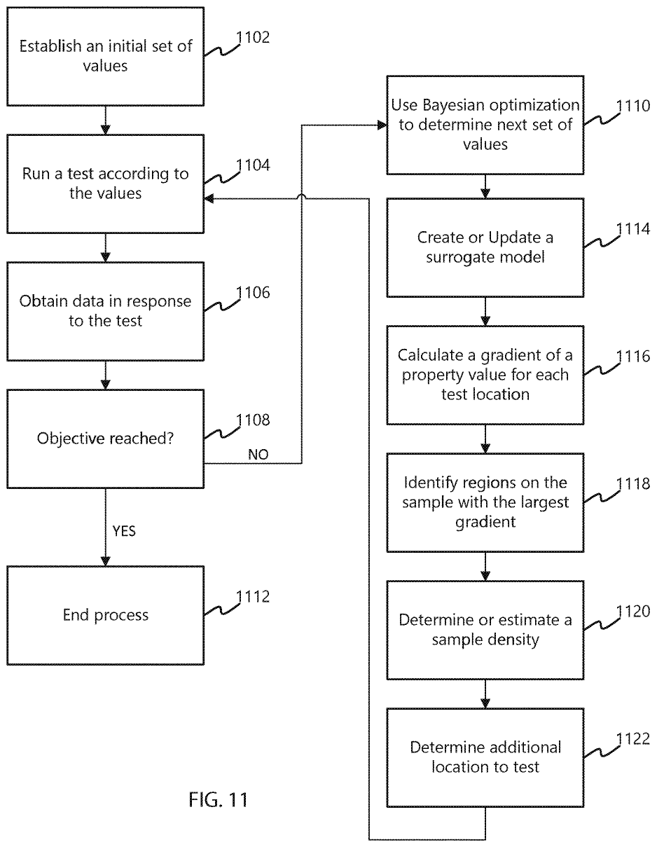

FIG. 11 is a flowchart depicting a method in accordance with various embodiments herein. In various embodiments provided herein, Bayesian optimization can be utilized to determine values for various variables in subsequent nanoindentation tests as mentioned above. In some embodiments, the variables can be coordinates, such as an X-coordinate and a Y-coordinate, for subsequent locations to test.

In some embodiments, the sample being tested can include multiple material phases. It some cases, it can be desirable to obtain additional data along the phase interface. However, testing an entire sample at the detailed desired for the phase interface can result in excess points being tested and time being wasted. In various embodiments, the phase interface is not visually obvious or otherwise known to a user. As an example, a dataset that is based on a 20 test location by 20 test location grid results in 400 points being tested. Increasing the dataset to include a grid of 40 test locations by 40 test locations results in 1600 points being tested, a 400% increase in the number of tests needed. In various embodiments, a Bayesian optimization process can be included in a nanoindentation process to target the phase interface automatically and efficiently. FIG. 11 shows a flowchart depicting a method of incorporating Bayesian optimization into nanoindentation to determine the location of subsequent tests in accordance with various embodiments herein.

In various embodiments, the method can include obtaining a sample. Prior to a test being performed on the sample, the method can include establishing initial values for a set of variables for a first nanoindentation test 1102. In some embodiments, this can include a batch of variables, such as to conduct a batch or multiple tests before analyzing the data. In various embodiments, a batch of variables can include a first set of values for the first set of variables, a second set of values for the first set of variables, and a third set of values for the first set of variables, such as in order to conduct three nanoindentation tests. In other embodiments, this can include a single set of values for the set of variables. In this example, the variable being evaluated can include coordinates on the sample, such as locations of the sample to be tested.

Once the values for the variables have been established, one or more experiments or tests can be conducted 1104. The one or more tests can be run in accordance with the values established in step 1102. In response to conducting the test(s), data can be obtained as an output from the test 1106.

Based on the output of the test(s), it can be decided whether or not the objective of the testing has been met 1108. If the objective has been met, the process can be terminated or stopped 1112. If the objective has not yet been met, Bayesian optimization can be used to determine the next values for the set of variables for a subsequent test 1110.

Using Bayesian optimization to determine the next set of values for the variables (e.g., a next set of coordinates for the next test) can include updating or creating a surrogate model to approximate an objective function 1114.

In various embodiments, the surrogate mode can use a kernel function to calculate the modulus at various locations on the sample. From this, the steepest gradient of the modulus at each point in the X-Y plane can also be calculated. The decision policy can aim to identify regions where the sample properties are rapidly changing and can bunch or group its suggested next test locations to these regions, since these regions are typically of the most interest to researchers. From this, the next set of values (i.e., the next set of coordinates) can be established 1116. Once the next set of values is determined, the method can return to step 1104 using the newly established values.

The method can further include calculating the property value at each location that was tested. The method can then include calculating a gradient of the property values across the sample 1116. In various embodiments the gradient function can include a gradient descent or a Nelder-Mead.

In various embodiments, after the gradient of the property values has been determined, the method can include identifying regions on the sample with a proper extreme value 1118, such as a largest gradient. The portions on the sample with a proper extreme value can be those of the most interest to researchers, since they represent areas where the properties are rapidly changing.

The method can further include determining or estimating the sample density 1120, such as to determine the confidence of the gradient in various areas. The method can also include determining the addition locations to test 1122, such as by balancing the sample density and the areas with a proper extreme value.

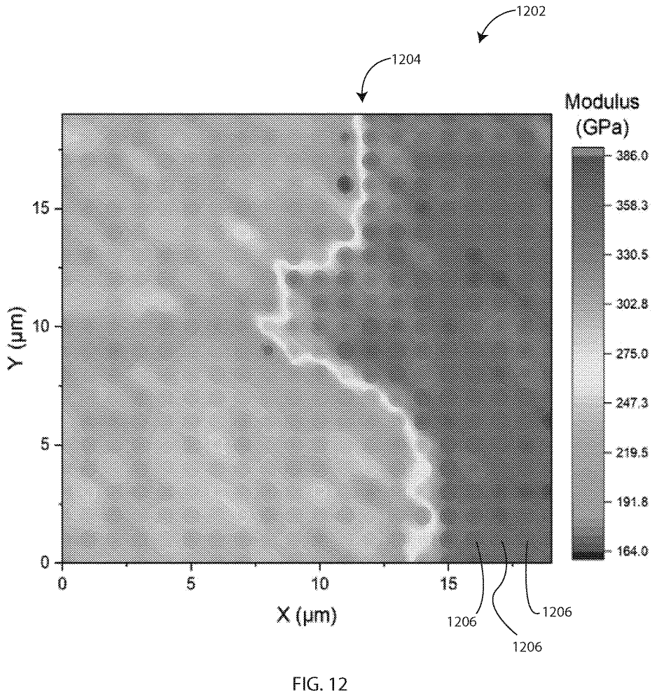

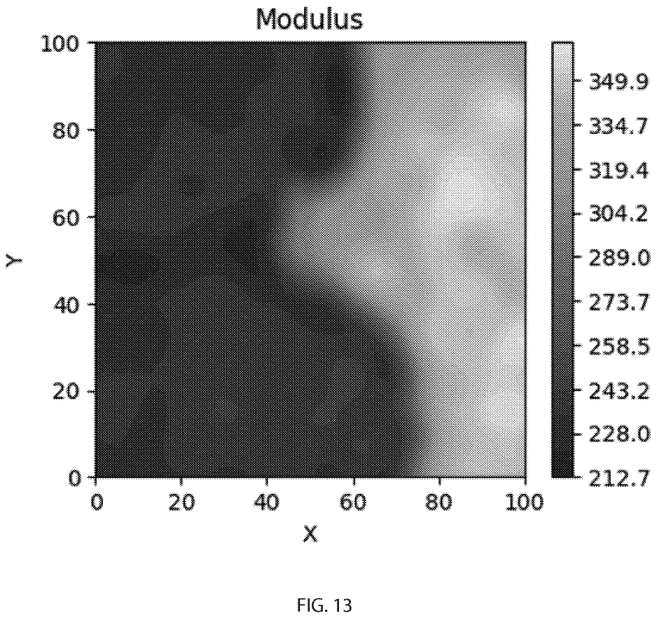

FIG. 12 shows a schematic of a portion of a sample 1202 for a nanoindentation process in accordance with various embodiments herein. A plurality of testing location 1206 are shown in FIG. 12. For clarity FIG. 13 shows a schematic of the sample 1202 without the test locations 1206.

The sample 1202 shown in FIG. 12 has been tested 400 times. The sample has been tested in a 20 by 20 grid configuration. This grid shaped pattern can provide a general indication of the sample's properties across the sample. In various embodiments, an initial test can include a standard or grid shaped pattern, such as shape that includes an equal distribution of sample locations. The shading of the sample depicts the modulus at each point. While shown in FIG. 12, the modulus of every point on the sample would not be known without significant testing. The modulus is shown in FIG. 12 for explanation purposes.

It can be seen that the that the sample includes a phase interface 1204. The phase interface 1204 extends from 0 μm to 20 μm in the Y-direction (across the entire portion of the sample) and the phase interface 1204 is generally between 7 μm and 15 μm in the X-direction. The sample has been tested at the various location 1206 in a first batch of testing, which can align with Step 1104 from FIG. 11.

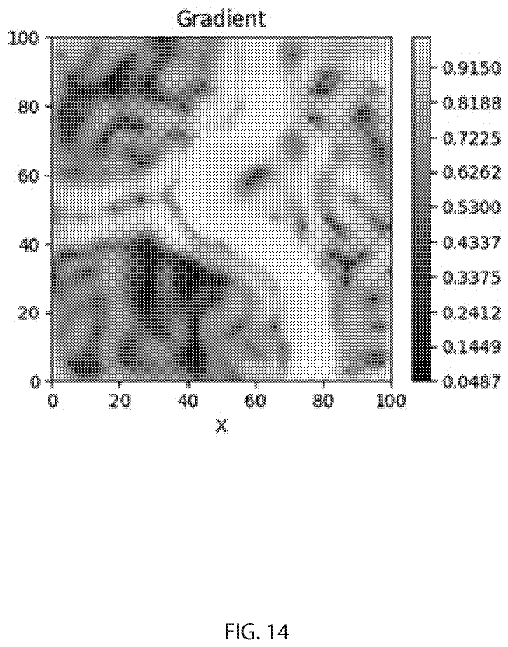

FIG. 14 shows a gradient of modulus changes across the sample. The phase interface has the highest gradient (i.e., the most amount of change). The areas where the gradient is the highest in this example are the areas where additional testing can be desired.

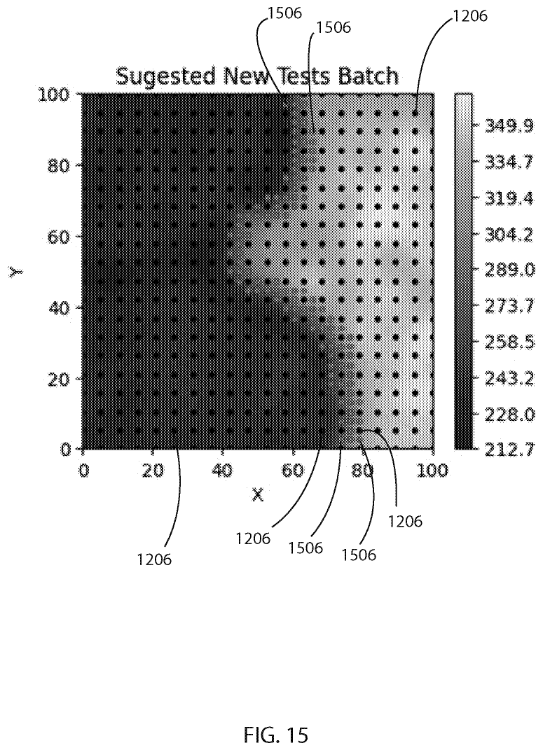

FIG. 15 shows a schematic of a portion of the sample shown in FIG. 12. The suggested new test locations 1506 are shown in addition to the previously tested locations 1206. It can be seen that the second batch of tests more closely follow the phase interface than the first batch of tests. The steps of determining a next batch of test locations can be repeated.

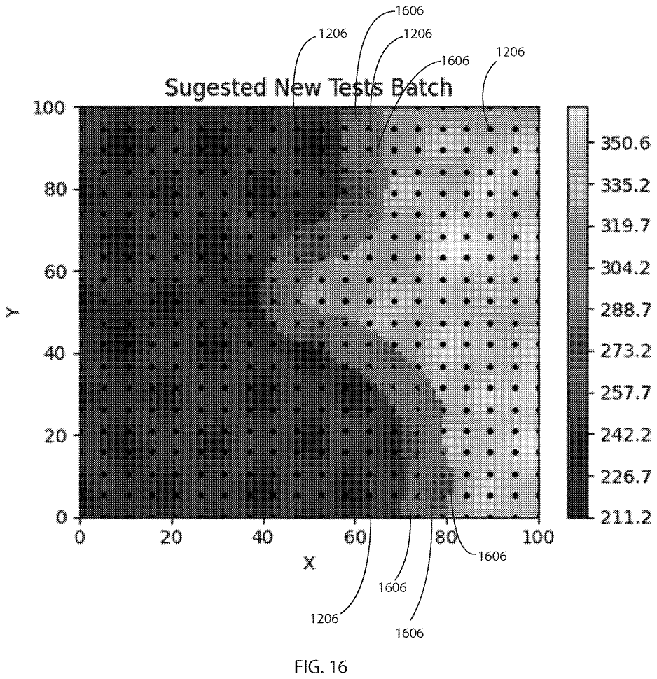

FIG. 16 shows a schematic of a portion of the sample shown in FIGS. 12 and 15. The suggested new test locations 1606 are shown in addition to the previously tested locations 1206, 1506. It can be seen that the third batch of tests more closely follow the phase interface than the first batch and second batch of tests.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A method of conducting a nanomechanical process, comprising:
(a) establishing a first set of values for a set of variables, a second set of values for the set of variables, and a third set of values for the set of variables;
(b) running a first nanomechanical test according to the first set of values for the set of variables;
(c) obtaining a first set of data in response to running the first nanomechanical test;
(d) running a second nanomechanical test according to the second set of values for the first set of variables;
(e) obtaining a second set of data in response to running the second nanomechanical test;
(f) running a third nanomechanical test according to the third set of values for the first set of variables;
(g) obtaining a third set of data in response to running the third nanomechanical test;
(h) using Bayesian optimization of the first set of data, the second set of data, and the third set of data to determine a fourth set of values for the first set of variables; and
(i) running a fourth nanomechanical test according to the fourth set of values for the first set of variables to obtain a fourth set of data.

2. The method of claim 1, wherein Bayesian optimization of step (h) comprises:
i. creating a surrogate model to approximate an objective function;
ii. using the surrogate model to estimate the similarity between the first set of values, the second set of values, and the third set of values;
iii. utilizing a decision policy to sample the surrogate model; and
iv. utilizing the decision policy to use an acquisition function to determine the fourth set of values for the first set of variables.

3. The method of claim 2, wherein a Gaussian process is used to create and/or update the surrogate model.

4. The method of claim 2, further comprising:
i. updating the surrogate model according to the fourth set of data;
ii. utilizing the decision policy to use the acquisition function to determine a fifth set of values for the first set of variables.
iii. running a fifth nanomechanical test according to the fifth set of values for the first set of variables to obtain a fifth set of data.

5-11. (canceled)

12. The method of claim 1, wherein the first set of variables comprises at least two of the following: time for hold segment, time for unload segment, approach speed, time for a preloading segment, approach parameters to ensure adequate offset to test on a virgin surface, loading rate, loading type, drift analysis, maximum force, maximum displacement, displacement rate, test temperature, and dynamic parameters.

13. The method of claim 1, wherein step (h) further comprises determining a fifth set of values for the first set of variables and a sixth set of values for the first set of variable; and
step (i) further comprises running a fifth nanomechanical test according to the fifth set of value for the first set of variable to obtain a fifth set of data and running a sixth nanomechanical test according to the sixth set of values for the first set of variables to obtain a sixth set of data.

14. The method of claim 13, further comprising
incorporating the fourth set of data, the fifth set of data, and the sixth set of data into the Bayesian optimization process of step (h);
using Bayesian optimization to determine a seventh set of values for the first set of variables, and
running a seventh nanomechanical test according to the seventh set of values for the first set of variables.

15-17. (canceled)

18. A nanomechanical system, comprising:
a tool head comprising a tool probe, the tool probe comprising a probe tip;
a sample stage configured for a sample to be placed upon;
an actuator configured to move the probe tip into contact with a sample disposed on the sample stage;
a control system comprising non-transitory memory including instructions to perform the steps of:
(a) establishing a first set of values for a set of variables, a second set of values for the set of variables, and a third set of values for the set of variables;
(b) running a first nanomechanical test according to the first set of values for the set of variables;
(c) obtaining a first set of data in response to running the first nanomechanical test;
(d) running a second nanomechanical test according to the second set of values for the first set of variables;
(e) obtaining a second set of data in response to running the second nanomechanical test;
(f) running a third nanomechanical test according to the third set of values for the first set of variables;
(g) obtaining a third set of data in response to running the third nanomechanical test;
(h) using Bayesian optimization of the first set of data, the second set of data, and the third set of data to determine a fourth set of values for the first set of variables; and
(i) running a fourth nanomechanical test according to the fourth set of values for the first set of variables to obtain a fourth set of data.

19. The system of claim 18, wherein Bayesian optimization of step (h) comprises:
i. creating a surrogate model to approximate an objective function;
ii. using the surrogate model to estimate the similarity between the first set of values, the second set of values, and the third set of values;
iii. utilizing a decision policy to sample the surrogate model; and
iv. utilizing the decision policy to use an acquisition function to determine the fourth set of values for the first set of variables.

20. The system of claim 19, wherein a Gaussian process is used to create and/or update the surrogate model.

21. The system of claim 19, further comprising:
i. updating the surrogate model according to the fourth set of data;
ii. utilizing the decision policy to use the acquisition function to determine a fifth set of values for the first set of variables.
iii. running a fifth nanomechanical test according to the fifth set of values for the first set of variables to obtain a fifth set of data.

22-28. (canceled)

29. The system of claim 18, wherein the first set of variables comprises at least two of the following: time for hold segment, time for unload segment, approach speed, time for a preloading segment, approach parameters to ensure adequate offset to test on a virgin surface, loading rate, loading type, drift analysis, maximum force, maximum displacement, displacement rate, test temperature, and dynamic parameters.

30. The system of claim 18, wherein step (h) further comprises determining a fifth set of values for the first set of variables and a sixth set of values for the first set of variable; and
step (i) further comprises running a fifth nanomechanical test according to the fifth set of value for the first set of variable to obtain a fifth set of data and running a sixth nanomechanical test according to the sixth set of values for the first set of variables to obtain a sixth set of data.

31. The system of claim 30, further comprising incorporating the fourth set of data, the fifth set of data, and the sixth set of data into the Bayesian optimization process of step (h);
using Bayesian optimization to determine a seventh set of values for the first set of variables, and
running a seventh nanomechanical test according to the seventh set of values for the first set of variables.

32. The system of claim 18, wherein the instructions further include the steps of:
using Bayesian optimization of a set of data that comprises the data from previously run tests to determine a new set of values for the set of variables for an additional test; and
running the additional test according to the new set of values to obtain additional data;
wherein the step of using Bayesian optimization to determine a new set of values for the variables and running the additional test to obtain additional data are repeated until a predefined stopping criterion is met.

33. The system of claim 18, wherein the nanomechanical system is a nanoindentation system and each of the nanomechanical tests is a nanoindentation test or a nanoscratch test.

34-41. (canceled)

42. A nanomechanical system, comprising:
a tool head comprising a tool probe, the tool probe comprising a probe tip;
a sample stage configured for a sample to be placed upon;
an actuator configured to move the probe tip into contact with a sample disposed on the sample stage;
a control system comprising non-transitory memory storing instructions to perform the steps of:
obtaining a sample;
running a first nanomechanical test at a first location on the sample to obtain a first set of data, at a second location on the sample to obtain a second set of data, and a third location on the sample to obtain a third set of data;
using Bayesian optimization of the first set of data, the second set of data, and the third set of data to determine a set of additional locations to test on the sample; and
running a second nanomechanical test at the set of additional locations on the sample to obtain at least a fourth set of data.

43. The system of claim 42, wherein the set of additional locations to test comprises at least 10 test locations.

44. The system of claim 42, wherein each additional location comprises an X-coordinate and a Y-coordinate.

45. The system of claim 42, wherein the instructions further include the steps of:
using Bayesian optimization of a set of data that comprises the data from previously run tests to determine a new set of values for the set of variables for an additional test; and
running the additional test according to the new set of values to obtain additional data;
wherein the step of using Bayesian optimization to determine a new set of values for the variables and running the additional test to obtain additional data are repeated until a predefined stopping criterion is met.

46-47. (canceled)
